(19) United States
(12) Patent Application Publication
(10) Pub. No.: US 2015/0153028 A1
(43) Pub. Date: Jun. 4, 2015

(54) HOUSING FOR LED LIGHTING DEVICE

(71) Applicant: LIMITED LIABILITY COMPANY "DIS PLUS", Moscow (RU)

(72) Inventor: Yuriy Borisovich Sokolov, Fryazino Moskovskaya obl. (RU)

(73) Assignee: LIMITED LIABILITY COMPANY "DIS PLUS", Moscow (RU)

(21) Appl. No.: 14/405,002

(22) PCT Filed: Jul. 25, 2013
(86) PCT No.: PCT/RU2013/000637

§ 371 Date: Dec. 2, 2014

(51) Int. Cl. F21V 17/16; F21S 8/04

(52) U.S. Cl. CPC F21V 17/164; F21S 8/043; F21Y 2101/02

(57) ABSTRACT

The invention relates to lighting technology and specifically to LED lighting devices. The LED device contains walls which delimit a housing cavity of the LED device, said walls being made of electrically insulating material, and at least one of the walls being provided with a recess capable of accommodating a current source, which allows for replacing the current source without disassembling the lamp and also increases electrical safety in using the lighting device by means of excluding galvanic mains decoupling elements.

### PERTINENT ART

This invention relates to illumination engineering, namely to the LED lighting devices designed mainly to create local and general indoor lighting.

### PRIOR ART

LED lighting devices known that contain a box housing, which side walls form a hollow prism, on whose upper base radiation sources are installed that are mounted on the board; and optically transparent plate fixed to the lower base of the prism (patent RU2301475, IPC H01063/06 published on 20 Jun. 2007, and the ZUMTOBEL company catalog, p.36, http//zumtobel.com/com-en/products/light_fields; or ceiling lamps PowerBalance, www.lighting.philips.com/ru-ru/index.wpd).

The known analogues contain features similar to the essential features of the claimed device. However, the mechanism of interconnection of the housing side walls is not explained in these analogues and the location of the current source (driver) powering the LEDs is not shown in the housing cavity.

The lamp is known that contains a shaped elongated housing made of extruded aluminum profile, which end surfaces are closed with detachable lids (application DE 202010004780 U1, IPC F21S8/04, published on 27 Oct. 2011).

The known solution has a box housing, but it is designed for fluorescent lamps, so power supply installation is not provided in the housing.

The closest to the claimed solution is a device described by the application KR20090019625 (A), IPC F21V15/01, published on 22 May 2009), which has a hollow housing bounded by sequentially placed walls and the wall connection joint with threaded elements.

The housing walls and means of their connection in the known solution are made of metal that imposes certain requirements on the design of the current source to power the LEDs and on features of its location in the housing cavity. In addition, usage of threaded joints to assembly the housing increases labour intensity and cost of production.

The claimed solution technical result is increase of electrical safety and production effectiveness as well as assembly simplification and lower operation costs.

### SOLUTION DETAILED DESCRIPTION

The LED lighting device housing is characterized by the combination of the following essential features:

The LED lighting device housing containing a cavity bounded by sequentially placed walls forming a closed loop, and a joint assembly provided with means of adjacent wall mechanical connection characterized that the walls are made of electrically insulating material, wherein at least one of the walls has a niche adapted to house a current source and is equipped with a cover to seal it.

As extending and/or refining features it should be specified the following invention features:
the means of the wall mechanical joint are made as two-link mechanism of elastic linkage closure. One of this mechanism links is located on one of the connected walls, wherein the response link is located on the connecting wall;
the housing wall may be equipped with at least one mechanical joint assembly manufactured as a single part with the wall. It should be noted that the option with two mechanical joint assemblies on each of the opposite housing walls is easier to assemble, but in increases assembly unit number;

The term “electrically insulating material” means a plastic mass or a composite that has electrical insulating properties and is suitable to manufacture the device structural elements using any shaping method, for example, the pressure casting. In particular, ABS plastics or polycarbonate may be used.

Usage of electrically insulating plastics allows to significantly simplify the power supply (driver) circuit by eliminating the elements of galvanic isolation from the mains.

The housing wall cavity with a niche to place the driver and a cover from the outer side of the wall allows the current source replacement without dismantling the lighting device with corresponding reduction of operation costs.

### BRIEF DESCRIPTION OF THE DRAWINGS

The following figures illustrate the proposed solution:

FIG. 1 shows an axonometric overall view of the lighting device quadrilateral housing;

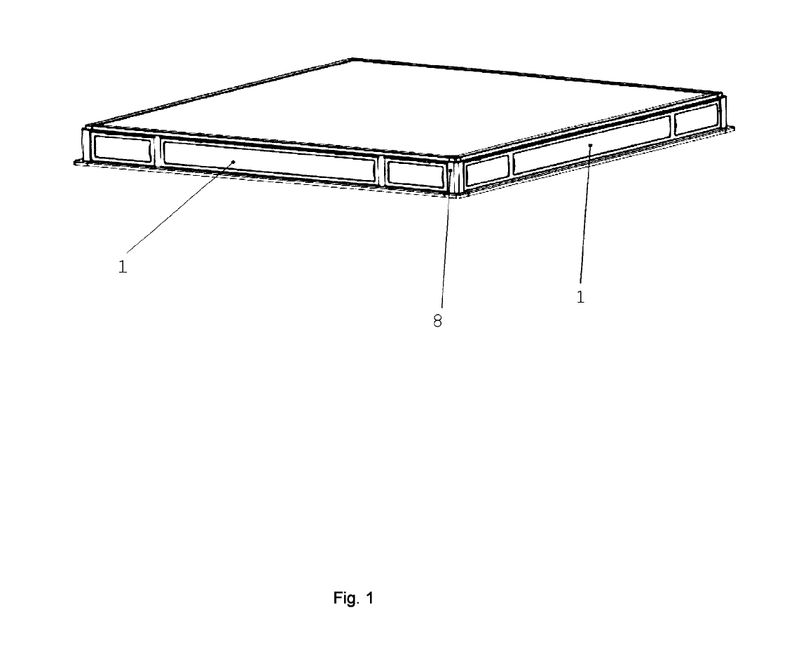

FIG. 2 shows a cross-sectional view of the device shown in FIG. 1;

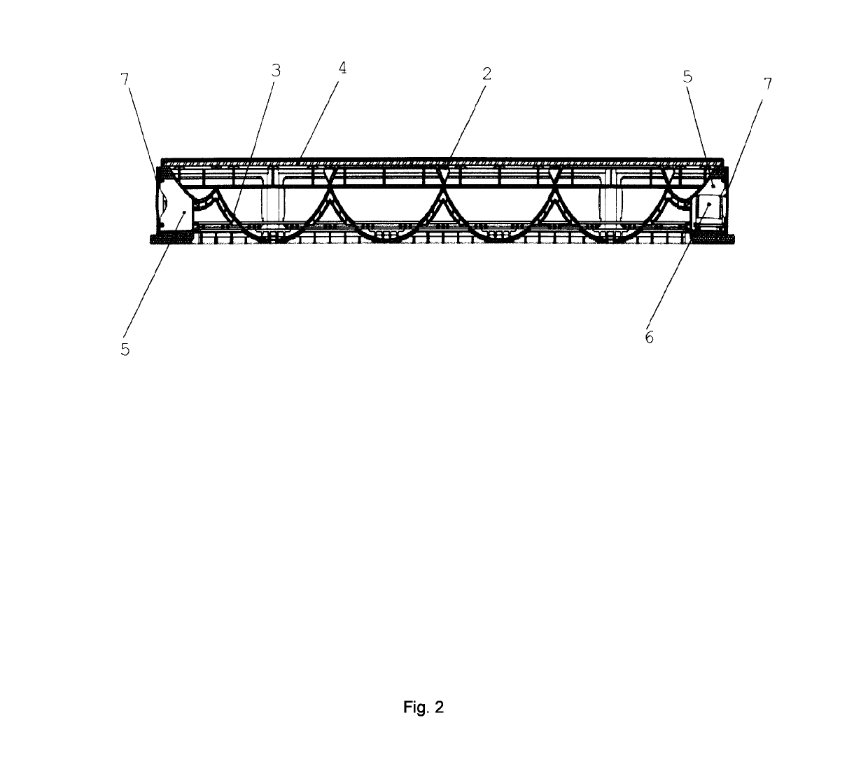

FIG. 3 is an axonometric view of the option of the disassembled lighting device shown in FIG. 1;

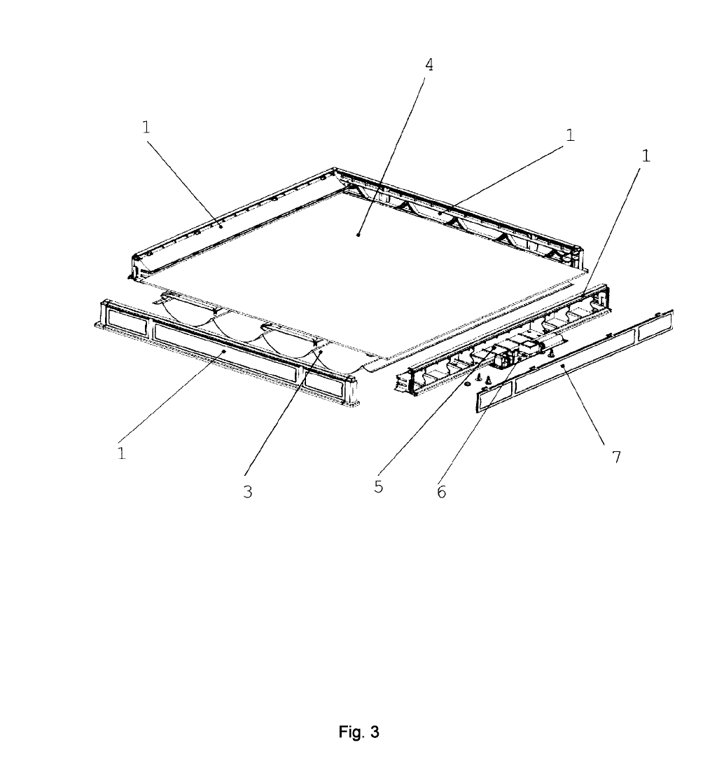

FIG. 4 shows an enlarged view of the assembly to join the device housing adjacent sides;

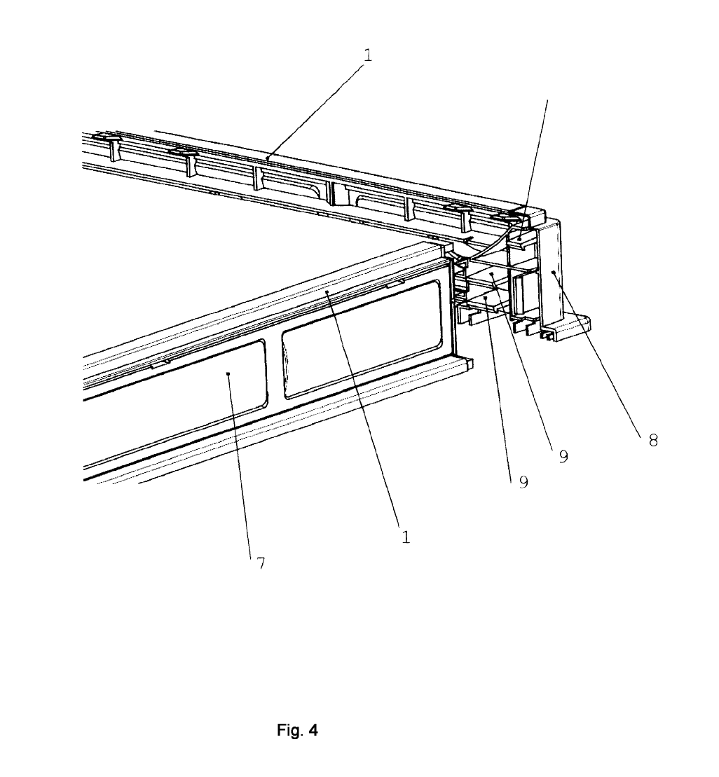

FIG. 5 is an axonometric view of the device shown in FIG. 1 with the open housing niche cover.

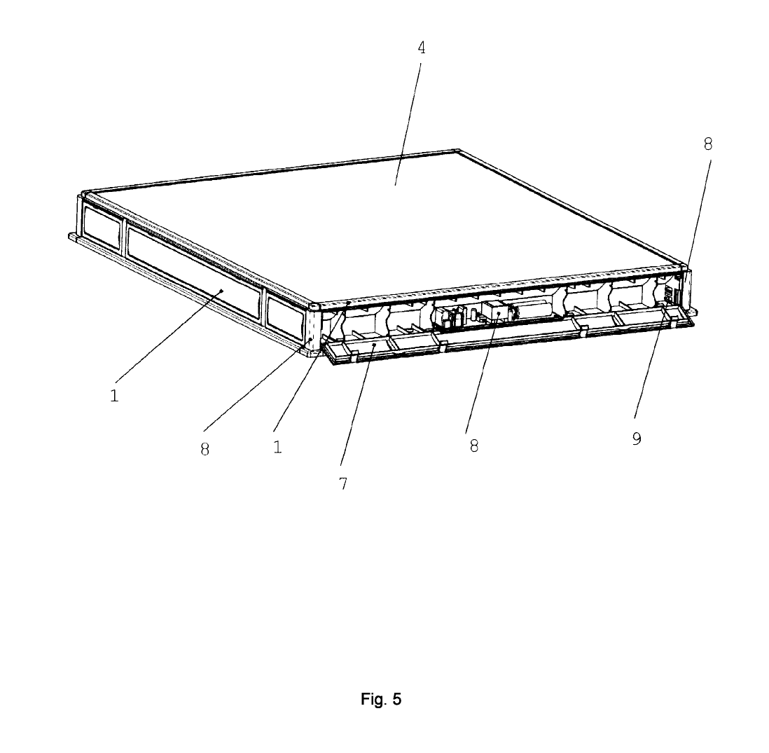

The LED lighting device housing 1 contains the walls 1 forming a closed loop and a cavity, which houses the device functional elements: LEDs 2, a reflector 3 and a diffuser plate 4 located near each comb. At least one of the housing walls has a niche 5 to install a driver 6 and is equipped with a cover 7 manufactured with ability to seal the niche 5 from direct exposure of environment. If necessary the second driver may be installed in the niche of the housing opposed wall.

In the particular case an assembly 8 mechanically connecting the housing walls 1 may be made as two-link mechanism, which elastic link 9 is made with ability to lock in the reply link (not shown) on the housing attached wall.

### INDUSTRIAL APPLICABILITY

Parts and components of the lighting device may be manufactured by the known methods. Information contained in the description is enough for a professional to understand the principle of work and the design of devices that implement the methods of creating light-emitting surface.

1. A LED lighting device housing containing a cavity bounded by sequentially placed walls forming a closed loop and a joint assembly provided with means of adjacent wall mechanical connection wherein the sequentially placed walls comprise an electrically insulating material, and wherein at least one of the sequentially placed walls comprises a niche adapted to house a current source and is equipped with a cover to seal the niche.

2. The LED lighting device housing according to claim 1 wherein the means of the adjacent wall mechanical connection comprises a two-link mechanism comprising an elastic linkage closure.

3. The LED lighting device housing according to claim 2, wherein a first link of the two-link mechanism is located on a first wall and a second link is located on a second wall being connected to the first wall.

4. The LED lighting device housing according to claim 1, wherein the sequentially placed walls are equipped with at least one mechanical joint assembly manufactured as a single part with at least one of the sequentially placed walls.

5. The LED lighting device housing according to claim 1, wherein the electrically insulating material comprises an electrically insulating plastic.

6. The LED lighting device housing according to claim 5, wherein the electrically insulating material comprises at least one of an ABS plastic and a polycarbonate.

7. The LED lighting device housing according to claim 1, wherein the device comprises a first and a second driver and wherein the first driver is disposed in a first wall and the second driver is disposed in a second wall.
